(19) United States
(12) Patent Application Publication
(10) Pub. No.: US 2005/0096052 A1
(43) Pub. Date: May 5, 2005

(54) System and method for providing reliable hard handoffs between wireless networks

(75) Inventors: John S. Csapo, Dallas, TX (US); Jonathan E. Reger, Sachse, TX (US); Joseph R. Cleveland, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/696,502

(22) Filed: Oct. 29, 2003

(51) Int. Cl. H04Q 7/20

(52) U.S. Cl. 455/439; 455/436

(57) ABSTRACT

A border base station capable of providing reliable hard handoffs between a first wireless network and a second wireless network is provided that includes a base station controller, a first base transceiver station and a transition base transceiver station. The base station controller is operable to manage communications resources within the first wireless network. The first base transceiver station is coupled to the base station controller. The first base transceiver station is operable to provide communication for a mobile station in the first wireless network. The transition base transceiver station is coupled to the base station controller and is located in proximity to a second base transceiver station. The transition base transceiver station is operable to provide communication for the mobile station in the second wireless network. The second base transceiver station is part of the second wireless network and is operable to provide communication for the mobile station in the second wireless network.

### TECHNICAL FIELD OF THE INVENTION

The present invention relates generally to wireless communication systems and, more specifically, to a system and method for providing reliable hard handoffs between wireless networks.

### BACKGROUND OF THE INVENTION

When a mobile station crosses a boundary of the service area for a base station that is currently maintaining a connection with the mobile station and enters the service area for another is base station, a handoff of the mobile station from the former base station to the latter is performed. Without a handoff, service for the mobile station will be dropped. Thus, the handoff allows the mobile station to maintain continuous service while moving between service areas for different base stations. Generally, there are two types of handoffs: soft handoffs and hard handoffs.

A soft handoff establishes a new channel without terminating the original channel. Therefore, the mobile station is in communication with at least one base station during the soft handoff process. On the other hand, a hard handoff terminates the original channel before establishing a new channel. A hard handoff typically occurs when the frequency channel, frame offset or system are changed.

One situation in which a hard handoff is performed is when the mobile station is moving from the coverage area of one network provider on one frequency to the coverage area of another network provider on another frequency. In order to perform a hard handoff in this type of situation, conventional methods include using pilot beacons and pilot signal strength measurements.

For the pilot beacon method, when the mobile station reaches an overlap region between the two networks, the mobile station detects a pilot beacon signal transmitted at the second frequency by a base transceiver station in the second network (the target base transceiver station). The mobile station then reports the signal quality in terms of the signal-to-interference ratio (Ec/Io) of the pilot beacon signal to the base transceiver station in the first network (the source base transceiver station) through a Pilot Strength Measurement Message (PSMM) transmitted at the first frequency. Upon receiving the PSMM from the mobile station, the source base transceiver station determines that the pilot beacon signal is at a suitable level and initiates a hard handoff for the mobile device such that the mobile device may begin communicating with the target base transceiver station at the second frequency.

Similar to the pilot beacon method, the pilot signal strength measurement method includes a mobile station entering the overlap region between the two networks and detecting a pilot signal transmitted at the second frequency by the target base transceiver station. The mobile station then reports the signal quality of the pilot signal to the source base transceiver station through a PSMM transmitted at the first frequency. The PSMM includes signal quality data for all pilots detected by the mobile station. Upon receiving the PSMM from the mobile station, the source base transceiver station uses the pilot strength information to determine whether a hard handoff should be performed. If the pilot strength information indicates that a handoff can be sustained, the source base transceiver station triggers the hard handoff procedure to transfer service for the mobile station to the target base transceiver station.

Disadvantages associated with these methods include the need for additional hardware to produce and amplify the pilot beacon signal or the pilot signal. This increases the cost for provisioning target base transceiver stations to support the hard handoff across the boundary. In addition, the presence of the pilot beacon signal or the pilot signal at the second frequency increases the interference experienced by the mobile station communicating with the source base transceiver station at the second frequency. The interference reduces the capacity of the source base transceiver station with regard to the second frequency and causes the source base transceiver station to use more transmit power on the forward links in order to communicate with mobile stations.

Furthermore, systems should enable a second cell when the signal strength of the second cell is considerably above (e.g., 6 dB) that of the first cell in order to avoid frequent handoffs, which require excessive control signaling, on the boundary between cells. This further degrades performance on the boundary between cells. Since Code Division Multiple Access (CDMA) network design typically assumes soft handoff gain is 3 dB, the probability for a signal of nominal strength 6 dB above that for the first cell is low. Therefore, conventional hard handoff procedures have a lower reliability than conventional soft handoff procedures. Also, because the value of Ec/Io measured and reported by the mobile station is dependent on cell loading, there is additional uncertainty in the relationship of the mobile station to the network boundary. The reliability is further degraded in radio frequency (RF) conditions with multi-path or log-normal shadowing. Finally, the trigger of the handoff causes the handoff to occur in an RF environment in the overlap region of the two networks where the signal strength is insufficient to support reliable service transfer from the source base transceiver station to the target base transceiver station.

### SUMMARY OF THE INVENTION

In accordance with the present invention, a system and method for providing reliable hard handoffs between wireless networks are provided that substantially eliminate or reduce disadvantages and problems associated with conventional systems and methods.

According to one embodiment of the present invention, a border base station capable of providing reliable hard handoffs between a first wireless network and a second wireless network is provided that includes a base station controller, a first base transceiver station and a transition base transceiver station. The base station controller is operable to manage communications resources within the first wireless network. The first base transceiver station is coupled to the base station controller. The first base transceiver station is operable to provide communication for a mobile station in the first wireless network. The transition base transceiver station is coupled to the base station controller and is located in proximity to a second base transceiver station. The transition base transceiver station is operable to provide communication for the mobile station in the second wireless network. The second base transceiver station is part of the second wireless network and is operable to provide communication for the mobile station in the second wireless network.

According to another embodiment of the present invention, a method for providing reliable hard handoffs between a first wireless network and a second wireless network is provided for use in a border base station in the first wireless network. The method includes performing a soft handoff for a mobile station between a first base transceiver station in the first wireless network and a transition base transceiver station in the first wireless network. A hard handoff is performed for the mobile station between the transition base transceiver station and a second base transceiver station in the second wireless network. The transceiver base transceiver station is located in proximity to the second base transceiver station.

Technical advantages of one or more embodiments of the present invention include providing an improved method for providing reliable hard handoffs between a first wireless network and a second wireless network. In a particular embodiment, a transition base transceiver station for the first wireless network is located in proximity to a base transceiver station in the second wireless network. As a result, a soft handoff may be performed for a mobile station between a base transceiver station in the first wireless network and the transition base transceiver station, while a hard handoff may be performed for the mobile station between the transition base transceiver station and the base transceiver station in the second wireless network. Therefore, a handoff is accomplished between the base transceiver station in the first wireless network and the base transceiver station in the second wireless network, with the only hard handoff performed being between the transition base transceiver station and the base transceiver station in the second wireless network. Accordingly, the hard handoff is performed between base transceiver stations in proximity to each other, resulting in a reliable hard handoff.

Other technical advantages will be readily apparent to one skilled in the art from the following figures, description, and claims.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 is a block diagram illustrating a general overview of a first wireless network according to one embodiment of the present invention;

FIGS. 2A-B are block diagrams illustrating in greater detail selected portions of the first wireless network of FIG. 1 and selected portions of a second wireless network according to one embodiment of the present invention;

FIG. 3 is a flow diagram illustrating a method for providing reliable hard handoffs between wireless networks in accordance with one embodiment of the present invention corresponding to FIG. 2A; and

FIG. 4 is a flow diagram illustrating a method for providing reliable hard handoffs between wireless networks in accordance with another embodiment of the present invention corresponding to FIG. 2B.

### DETAILED DESCRIPTION OF THE INVENTION

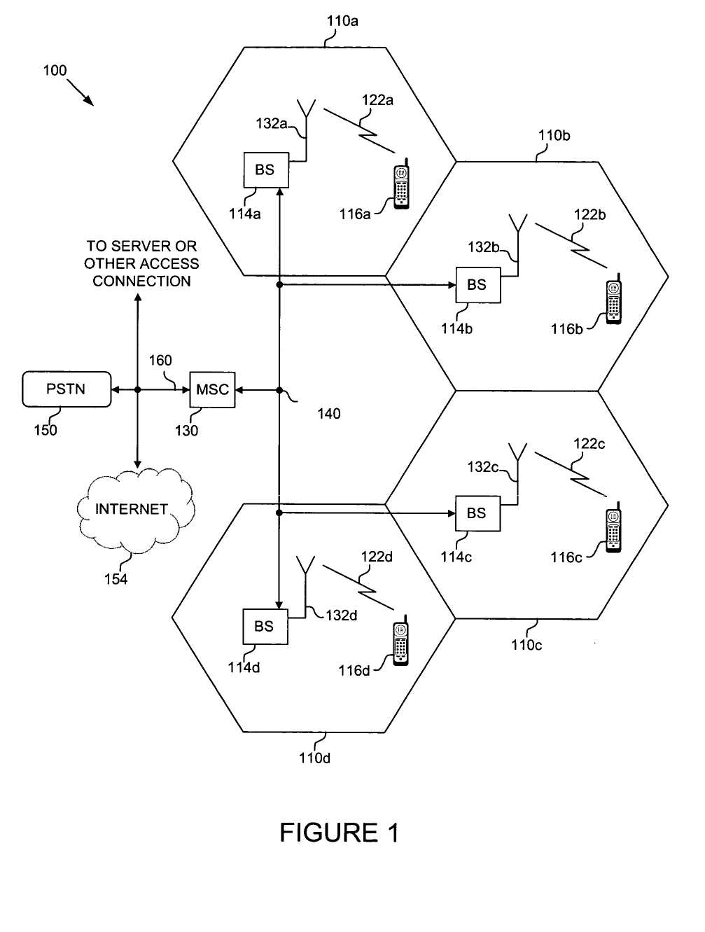

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless communication system.

FIG. 1 is a block diagram illustrating a general overview of a first wireless network 100 according to one embodiment of the present invention. The first wireless network 100 may comprise a Code Division Multiple Access (CDMA) network or other suitable type of wireless network.

The first wireless network 100 comprises a plurality of geographically dispersed cell sites 110 in which base stations (BSs) 114 are located. The base stations 114 are operable to communicate with a plurality of mobile stations 116. Radio frequency (RF) communication links 122 are operable to provide communication between the base stations 114 and the mobile stations 116. The mobile stations 116 may comprise any suitable cellular devices, such as conventional cellular telephones, portal handset devices, personal digital assistant devices, portable computers, metering devices, or the like.

The cells sites 110 are illustrated as idealized, interlocking hexagons. However, it should be noted that, in a typical wireless network, actual cell sites are irregularly shaped and overlap in non-uniform configurations, depending on the features of the terrain, such as natural obstructions, man-made obstructions, zoning restrictions, and the like. In addition, cell sites are often subject to other uncontrollable influences.

For simplicity and clarity, only a single base station 114 and a single mobile station 116 are shown and described in each cell site 110. In reality, however, one or more of the cell sites 110 may comprise multiple base stations 114, each of which may communicate with a plurality of mobile stations 116. As used herein, “each” means every one of at least a subset of the identified items.

In one embodiment of the present invention, each base station 114 may comprise a base station controller and one or more base transceiver stations. A base station controller is operable to manage the wireless communications resources, including the base transceiver stations, for specified cells 110 within the first wireless network 100. A plurality of base station controllers may be coupled to a single mobile switching center (MSC) 130. A base transceiver station comprises RF transceivers, antennas, and other circuitry and electrical equipment for its cell site 110.

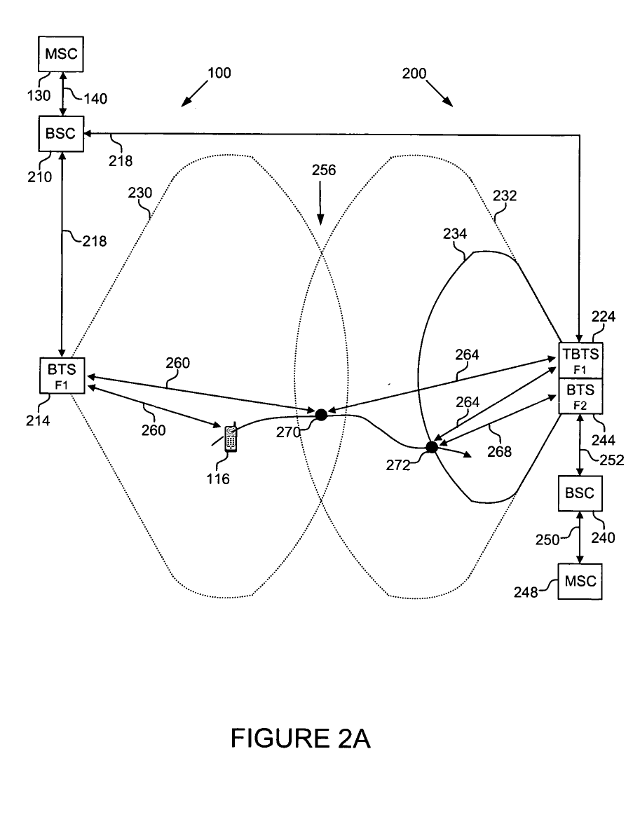

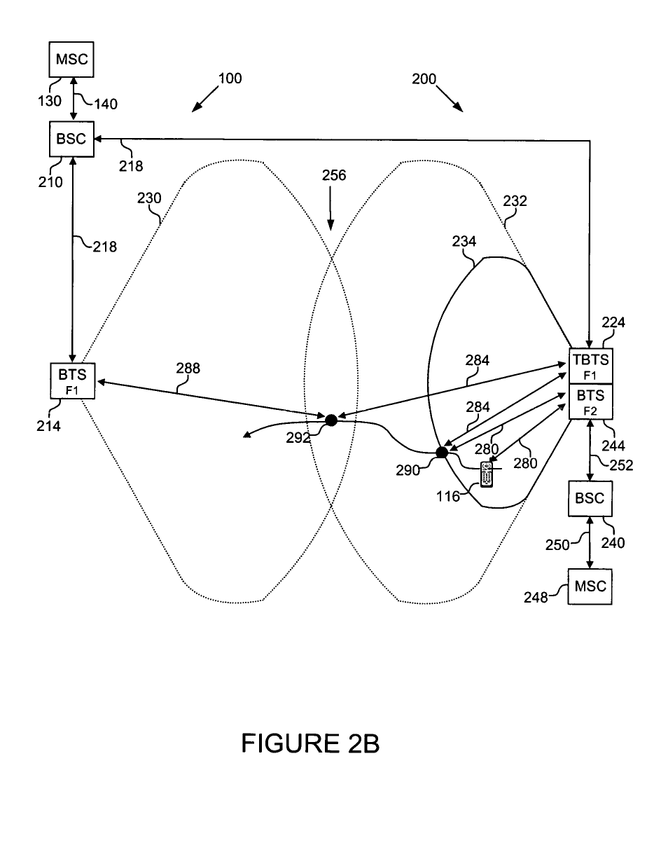

At least one of the base stations 114 is a border base station 114. The cell site 110 in which the border base station 114 is located lies at the outer edge of a coverage area for the first wireless network 100 such that another wireless network provides coverage at an adjacent cell site. The border base station 114 comprises at least two base transceiver stations, including one transition base transceiver station. The transition base transceiver station is located within the adjacent cell site of the other wireless network and is operable to provide reliable hard handoffs between the wireless networks, as described in more detail below in connection with FIGS. 2A-B.

In one embodiment of the present invention, each base station 114 comprises an antenna array 132. The antenna array 132 may comprise a multi-sector antenna, such as a three-sector antenna, in which each antenna sector is responsible for transmitting and receiving in a 120° arc of coverage area. Additionally, each antenna array 132 may employ well-known diversity reception techniques, wherein a main antenna and a diversity antenna are co-located on an antenna tower.

In the illustrated first wireless network 100, mobile station 116a is located in cell site 110a and is operable to communicate with base station 114a, mobile station 116b is located in cell site lob and is operable to communicate with base station 114b, mobile station 116c is located in cell site 110c and is operable to communicate with base station 114c, and mobile station 116d is located in cell site 110d and is operable to communicate with base station 114d. However, it will be understood that each of the mobile stations 116 may move between cell sites 110 and is operable to communicate with the base station 114 located in the same cell site 110.

The base stations 114 are operable to communicate with each other and with the mobile switching center 130 via communication line 140. The mobile switching center 130 is operable to provide services for and coordination between the subscribers in the wireless network 100 and external networks, such as the Public Switched Telephone Network (PSTN) 150, Internet 154, a server or other communication access connection and the like, via communication line 160.

In operation, when a mobile station 116 is moving from one cell site 110 to another during a call, a handoff procedure transfers control of the call from the first cell site 110 to the second cell site 110. A handoff may be either a soft handoff or a hard handoff. In a soft handoff, a connection is made between the mobile station 116 and the base station 114 in the second cell site 110 before the existing connection is broken between the mobile station 116 and the base station 114 in the first cell site 110. In a hard handoff, the existing connection between the mobile station 116 and the base station 114 in the first cell site 110 is broken before a new connection is made between the mobile station 116 and the base station 114 in the second cell site 110.

For example, according to one embodiment, as mobile station 116a moves from cell site 110a to cell site 110b, mobile station 116a detects a pilot signal from base station 114b and sends a Pilot Strength Measurement Message to base station 114a. When the strength of the pilot signal transmitted by base station 114b and received and reported by mobile station 116a exceeds an add threshold, base station 114a may initiate a soft handoff process by signaling the target base station 114b that a handoff is required, as described in TIS/EIA IS-95 or the TIS/EIA IS-2000 family of standards.

Base station 114b and mobile station 116a proceed to negotiate establishment of a communications link in the CDMA channel. Following establishment of the communications link between base station 114b and mobile station 116a, mobile station 116a communicates with both base station 114a and base station 114b in a soft handoff mode. This soft handoff improves the performance on both forward (base station 114 to mobile station 116) and reverse (mobile station 116 to base station 114) channel links. When the signal from base station 114a falls below a predetermined signal strength threshold, mobile station 116a may then drop the link with base station 114a and only receive signals from base station 114b. The call is thereby seamlessly transferred from base station 114a to base station 114b.

The above-described soft handoff assumes the mobile station 116 is in a voice or data call. An idle handoff, which is a handoff between cell sites 110 of a mobile station 116 that is communicating in the control or paging channel, may be performed in a similar manner.

FIGS. 2A-B are block diagrams illustrating in greater detail selected portions of the first wireless network 100 and selected portions of a second wireless network 200 according to one embodiment of the present invention. As described in more detail below, FIG. 2A illustrates a mobile station 116 moving from the first wireless network 100 into the second wireless network 200, while FIG. 2B illustrates a mobile station 116 moving from the second wireless network 200 into the first wireless network 100. Thus, the components of the selected portions of both wireless networks 100 and 200 illustrated in FIGS. 2A and 2B are the same. The second wireless network 200 is similar to the first wireless network 100 in that both wireless networks 100 and 200 comprise a plurality of base stations and mobile stations and also in that the second wireless network 200 may comprise a Code Division Multiple Access (CDMA) network or other suitable type of wireless network.

As illustrated in FIGS. 2A-B, the first wireless network 100 comprises a border base station 114, as described above in connection with FIG. 1. The border base station 114 comprises a base station controller (BSC) 210, a base transceiver station (BTS) 214 and a transition base transceiver station (TBTS) 224. The base station controller 210 is operable to communicate with the mobile switching center 130 through communication line 140. The base station controller 210 is also operable to communicate with the BTS 214 through communication line 218 and to communicate with the transition BTS 224 through the same communication line 218. The base station controller 210 is also operable to communicate with other base transceiver stations (not illustrated in FIGS. 2A-B) in the first wireless network 100 through communication line 218.

The first wireless network 100 is operable to provide communication within a first carrier coverage area 230 and within a second carrier coverage area 232. The second wireless network 200 is operable to provide communication within the second carrier coverage area 232. In addition, the second carrier coverage area 232 of the second wireless network 200 comprises a hard handoff region 234, which will be described in more detail below.

For simplicity and clarity, a single base station (comprising base station controller 240 and base transceiver station 244) is shown and described in the second wireless network 200. However, it will be understood that the second wireless network 200 may comprise multiple base stations, each of which is operable to communicate with a plurality of mobile stations 116. The second wireless network 200 also comprises a mobile switching center 248 that is operable to communicate with base station controller 240 through communication line 250. Furthermore, base station controller 240 is operable to communicate with base transceiver station 244 through communication line 252.

The BTS 214 is operable to provide communication on carrier frequency F1 within carrier coverage area 230, and the transition BTS 224 is operable to provide communication on carrier frequency F1 within the carrier coverage area 232. The BTS 244 is operable to provide communication on carrier frequency F2 within the carrier coverage area 232.

In one embodiment of the present invention, the transition base transceiver station 224 of the first wireless network 100 is located in proximity to the base transceiver station 244 of the second wireless network 200. Accordingly, the mobile station 116 may communicate with either carrier frequency F1 or carrier frequency F2 within the same carrier coverage area 232.

It should be noted that mobile switching center 130 of the first wireless network 100 and mobile switching center 248 of the second wireless network 200 may be operable to communicate with each other through the Public Switched Telephone Network (not shown in FIGS. 2A-B).

To explain the operation of a hard handoff between the wireless networks 100 and 200 for one embodiment of the present invention, an example is now given with reference to FIG. 2A. In the following example, the mobile station 116 is moving from the first wireless network 100 into the second wireless network 200. Therefore, carrier coverage area 230 of the first wireless network 100 is a “border coverage area” of the first wireless network 100 and carrier coverage area 232 of the second wireless network 200 is a “border coverage area” of the second wireless network 200. The geographical boundary between the wireless networks 100 and 200 lies within an overlap region 256 of the two carrier coverage areas 230 and 232. The wireless networks 100 and 200 may comprise radio frequency (RF) communication links, such as communication links 260, 264, and 268, that are operable to provide communication between base transceiver stations 214, 224 and 244 and a mobile station 116.

For this example, the mobile station 116 is initially located in the first wireless network 100 and is in communication with the border base station 114 comprising the base station controller 210, the BTS 214 and the transition BTS 224 on carrier frequency F1. The mobile station 116 is in the carrier coverage area 230 of the BTS 214 and is in communication with the BTS 214 through communication link 260.

As the mobile station 116 moves toward the border between the two wireless networks 100 and 200, a soft handoff from the BTS 214 to the transition BTS 224 will be performed. As illustrated in FIG. 2A, this soft handoff is performed at a location within the overlap region 256 of the two carrier coverage areas 230 and 232, such as point 270 in the illustrated example. After the soft handoff, the mobile station 116 will be in communication with the transition BTS 224 through communication link 264. Thus, the mobile station 116 may communicate through the base station controller 210 on carrier frequency F1 in both carrier coverage areas 230 and 232.

To perform the soft handoff in accordance with one embodiment, when the mobile station 116 determines that the strength of the pilot signal transmitted by the transition BTS 224 has exceeded an add threshold, the mobile station 116 sends a Pilot Strength Measurement Message (PSMM) to the base station controller 210 via a reverse traffic channel to the BTS 214. After receiving the PSMM, the base station controller 210 places the transition BTS 224 in the active set for the mobile station 116 and initiates a Handoff Direction Message (HDM). In this way, a soft handoff may be provided between the BTS 214 and the transition BTS 224.

As the mobile station 116 continues to move further into the second wireless network 200, the mobile station 116 may eventually reach the hard handoff region 234, such as at point 272 in the illustrated example. At this point, a hard handoff from the transition BTS 224 to the BTS 244 will be performed such that the mobile station 116 will be in communication with the BTS 244 through communication link 268. Thus, at point 272, the mobile station 116 may communicate through the base station controller 210 on carrier frequency F1 or through the base station controller 240 on carrier frequency F2.

To perform the hard handoff in accordance with one embodiment, when the base station controller 210 determines that a hard handoff threshold has been exceeded, the base station controller 210 signals the mobile switching center 130 that a handoff to the second wireless network 200 is about to be performed. The base station controller 210 also signals the mobile station 116 to perform a hard handoff from the transition BTS 224 on carrier frequency F1 to BTS 244 on carrier frequency F2. The mobile switching center 130 signals the mobile switching center 248 in accordance with the procedures described in TIS/EIA IS-41 or other suitable standard. In this way, a hard handoff may be provided between the transition BTS 224 and the BTS 244.

Thus, using this procedure, a handoff is accomplished from the BTS 214 on carrier frequency F1 to the BTS 244 on carrier frequency F2, with the only hard handoff being performed from the transition BTS 224 to the BTS 244. Because the transition BTS 224 and the BTS 244 are in proximity to each other, this hard handoff is more reliable than a hard handoff directly from the BTS 214 to the BTS 244.

To explain the operation of a hard handoff between the wireless networks 100 and 200 for one embodiment of the present invention, another example is now given with reference to FIG. 2B. In the following example, the mobile station 116 is moving from the second wireless network 200 into the first wireless network 100. The wireless networks 100 and 200 may comprise radio frequency (RF) communication links, such as communication links 280, 284, and 288, that are operable to provide communication between base transceiver stations 214, 224 and 244 and a mobile station 116.

For this example, the mobile station 116 is initially located in the second wireless network 200 and is in communication with a base station 114 comprising base station controller 240 and base transceiver station 244 on carrier frequency F2. The mobile station 116 is in the carrier coverage area 232 of the base transceiver station (BTS) 244, specifically in the hard handoff region 234, and is in communication with the BTS 244 through communication link 280.

As the mobile station 116 moves toward the first wireless network 100, the mobile station 116 may eventually reach the border of the hard handoff region 234, such as at point 290 in the illustrated example. At this point, a hard handoff from the BTS 244 to the transition BTS 224 will be performed such that the mobile station 116 will be in communication with the transition BTS 224 through communication link 284. Thus, at point 290, the mobile station 116 may communicate through the base station controller 240 on carrier frequency F2 or through the base station controller 210 on carrier frequency F1.

To perform the hard handoff in accordance with one embodiment, when the base station controller 240 determines that a hard handoff threshold has been exceeded, the base station controller 240 signals the mobile switching center 248 that a handoff to the first wireless network 100 is about to be performed. The base station controller 240 also signals the mobile station 116 to perform a hard handoff from the BTS 244 on carrier frequency F2 to the transition BTS 224 on carrier frequency F1. The mobile switching center 248 signals the mobile switching center 130 in accordance with the procedures described in TIS/EIA IS-41 or other suitable standard. In this way, a hard handoff may be provided between the BTS 244 and the transition BTS 224.

As the mobile station 116 continues to move toward the border between the two wireless networks 100 and 200, a soft handoff from the transition BTS 224 to the BTS 214 will be performed. As illustrated in FIG. 2B, this soft handoff is performed at a location within the overlap region 256 of the two carrier coverage areas 230 and 232, such as point 292 in the illustrated example. After the soft handoff, the mobile station 116 will be in communication with the BTS 214 through communication link 288. Thus, the mobile station 116 may communicate through the base station controller 210 on carrier frequency F1 in both carrier coverage areas 230 and 232.

To perform the soft handoff in accordance with one embodiment, when the mobile station 116 determines that the strength of the pilot signal transmitted by the BTS 214 has exceeded an add threshold, the mobile station 116 sends a Pilot Strength Measurement Message (PSMM) to the base station controller 210 via a reverse traffic channel to the transition BTS 224. After receiving the PSMM, the base station controller 210 places the BTS 214 in the active set for the mobile station 116 and initiates a HDM. In this way, a soft handoff may be provided between the transition BTS 224 and the BTS 214.

Thus, using this procedure, a handoff is accomplished from the BTS 244 on carrier frequency F2 to the BTS 214 on carrier frequency F1, with the only hard handoff being performed from the BTS 244 to the transition BTS 224. Because the transition BTS 224 and the BTS 244 are in proximity to each other, this hard handoff is more reliable than a hard handoff directly from the BTS 244 to the BTS 214.

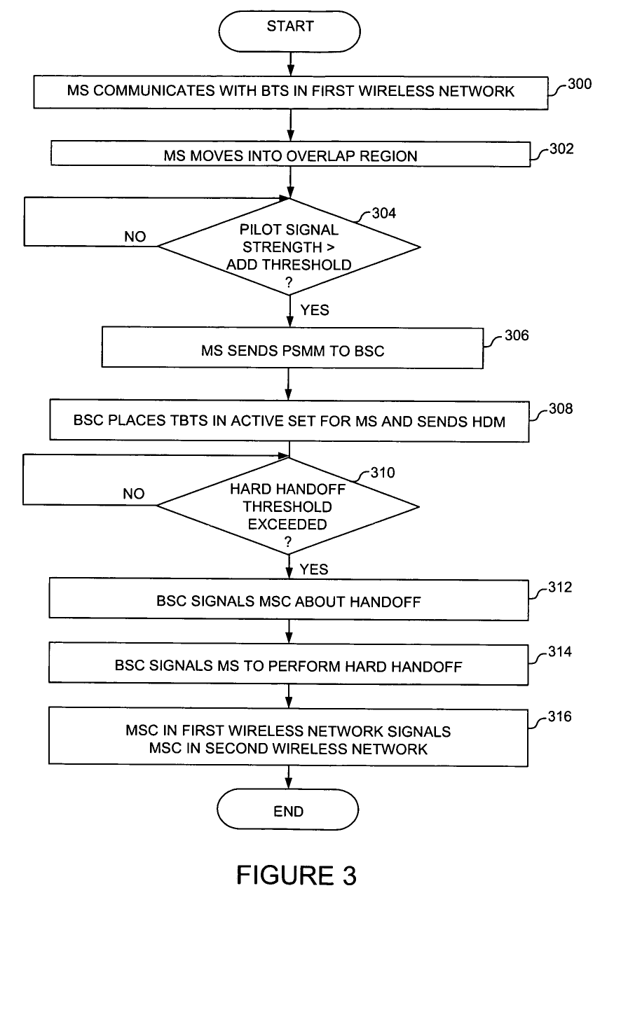

FIG. 3 is a flow diagram illustrating a method for providing reliable hard handoffs between wireless networks in accordance with one embodiment of the present invention. For this embodiment, the mobile station 116 is moving from the first wireless network 100 into the second wireless network 200. The method begins at step 300 where the mobile station 116 communicates with the BTS 214 on carrier frequency F1. At step 302, the mobile station 116 moves into the overlap region 256.

At decisional step 304, the mobile station 116 makes a determination regarding whether or not the strength of the pilot signal transmitted by the transition BTS 224 is greater than an add threshold. If the strength of the pilot signal transmitted by the transition BTS 224 is not greater than the add threshold, the method follows the No branch from decisional step 304 and remains at decisional step 304 until the strength of the pilot signal transmitted by the transition BTS 224 is greater than the add threshold. When the mobile station 116 determines that the strength of the pilot signal transmitted by the transition BTS 224 is greater than the add threshold, the method follows the Yes branch from decisional step 304 to step 306.

At step 306, the mobile station 116 sends a PSMM to the base station controller 210 via the reverse traffic channel to the BTS 214. At step 308, upon receiving the PSMM, the base station controller 210 places the transition BTS 224 in the active set for the mobile station 116 and initiates a HDM, concluding a soft handoff from the BTS 214 to the transition BTS 224.

At decisional step 310, the base station controller 210 makes a determination regarding whether or not a hard handoff threshold has been exceeded. If the hard handoff threshold has not been exceeded, the method follows the No branch from decisional step 310 and remains at decisional step 310 until the hard handoff threshold is exceeded. When the base station controller 210 determines that the hard handoff threshold has been exceeded, the mobile station 116 has reached the hard handoff region 234 and the method follows the Yes branch from decisional step 310 to step 312.

At step 312, the base station controller 210 signals the mobile switching center 130 that a handoff to the second wireless network 200 is about to be performed. At step 314, the base station controller 210 signals the mobile station 116 to perform a hard handoff from the transition BTS 224 on carrier frequency F1 to BTS 244 on carrier frequency F2. At step 316, the mobile switching center 130 signals the mobile switching center 248 in accordance with the procedures described in TIS/EIA IS-41 or other suitable standard, concluding a hard handoff from the transition BTS 224 to the BTS 244 and bringing the method to an end.

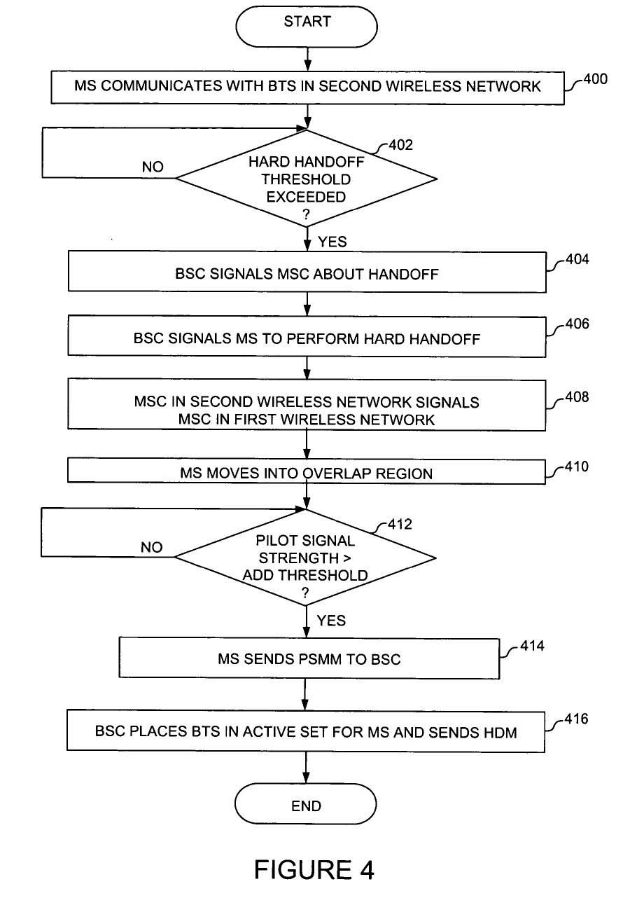

FIG. 4 is a flow diagram illustrating a method for providing reliable hard handoffs between wireless networks in accordance with another embodiment of the present invention. For this embodiment, the mobile station 116 is moving from the second wireless network 200 into the first wireless network 100. The method begins at step 400 where the mobile station 116 communicates with the BTS 244 on carrier frequency F2.

At decisional step 402, the base station controller 240 makes a determination regarding whether or not a hard handoff threshold has been exceeded. If the hard handoff threshold has not been exceeded, the method follows the No branch from decisional step 402 and remains at decisional step 402 until the hard handoff threshold is exceeded. When the base station controller 240 determines that the hard handoff threshold has been exceeded, the mobile station 116 has reached the border of the hard handoff region 234 and the method follows the Yes branch from decisional step 402 to step 404.

At step 404, the base station controller 240 signals the mobile switching center 248 that a handoff to the first wireless network 100 is about to be performed. At step 406, the base station controller 240 signals the mobile station 116 to perform a hard handoff from the BTS 244 on carrier frequency F2 to the transition BTS 224 on carrier frequency F1. At step 408, the mobile switching center 248 signals the mobile switching center 130 in accordance with the procedures described in TIS/EIA IS-41 or other suitable standard, concluding a hard handoff from the BTS 244 to the transition BTS 224.

At step 410, the mobile station 116 moves into the overlap region 256. At decisional step 412, the mobile station 116 makes a determination regarding whether or not the strength of the pilot signal transmitted by the BTS 214 is greater than an add threshold. If the strength of the pilot signal transmitted by the BTS 214 is not greater than the add threshold, the method follows the No branch from decisional step 412 and remains at decisional step 412 until the strength of the pilot signal transmitted by the BTS 214 is greater than the add threshold. When the mobile station 116 determines that the strength of the pilot signal transmitted by the BTS 214 is greater than the add threshold, the method follows the Yes branch from decisional step 412 to step 414.

At step 414, the mobile station 116 sends a PSMM to the base station controller 210 via the reverse traffic channel to the transition BTS 224. At step 416, upon receiving the PSMM, the base station controller 210 places the BTS 214 in the active set for the mobile station 116 and initiates a HDM, concluding a soft handoff from the transition BTS 224 to the BTS 214 and bringing the method to an end.

Although the present invention has been described with several embodiments, various changes and modifications may be suggested to one skilled in the art. It is intended that the present invention encompass such changes and modifications as fall within the scope of the appended claims.

1. For use in a first wireless network, a border base station capable of providing reliable hard handoffs between the first wireless network and a second wireless network, the border base station comprising:
a base station controller operable to manage communications resources within the first wireless network;
a first base transceiver station coupled to the base station controller, the first base transceiver station operable to provide communication for a mobile station in the first wireless network; and
a transition base transceiver station coupled to the base station controller and located in proximity to a second base transceiver station, the transition base transceiver station operable to provide communication for the mobile station in the second wireless network, the second base transceiver station part of the second wireless network and operable to provide communication for the mobile station in the second wireless network.

2. The border base station of claim 1, the base station controller further operable to perform a soft handoff for the mobile station between the first base transceiver station and the transition base transceiver station and to perform a hard handoff for the mobile station between the transition base transceiver station and the second base transceiver station.

3. The border base station of claim 2, the base station controller operable to perform the soft handoff for the mobile station between the first base transceiver station and the transition base transceiver station when the mobile station reaches an overlap region between the first wireless network and the second wireless network.

4. The border base station of claim 2, the base station controller operable to perform the hard handoff for the mobile station between the transition base transceiver station and the second base transceiver station when the mobile station reaches a border for a hard handoff region, the hard handoff region a portion of the second wireless network.

5. The border base station of claim 1, the first base transceiver station operable to provide communication for the mobile station in the first wireless network at a first carrier frequency, the transition base transceiver station operable to provide communication for the mobile station in the second wireless network at the first carrier frequency, and the second base transceiver station operable to provide communication for the mobile station in the second wireless network at a second carrier frequency.

6. A first wireless network comprising a plurality of border base stations, each one of the border base stations capable of providing reliable hard handoffs between the first wireless network and a second wireless network, each border base station comprising:
a base station controller operable to manage communications resources within the first wireless network;
a first base transceiver station coupled to the base station controller, the first base transceiver station operable to provide communication for a mobile station in the first wireless network; and
a transition base transceiver station coupled to the base station controller and located in proximity to a second base transceiver station, the transition base transceiver station operable to provide communication for the mobile station in the second wireless network, the second base transceiver station part of the second wireless network and operable to provide communication for the mobile station in the second wireless network.

7. The wireless network of claim 6, the base station controller further operable to perform a soft handoff for the mobile station between the first base transceiver station and the transition base transceiver station and to perform a hard handoff for the mobile station between the transition base transceiver station and the second base transceiver station.

8. The wireless network of claim 7, the base station controller operable to perform the soft handoff for the mobile station between the first base transceiver station and the transition base transceiver station when the mobile station reaches an overlap region between the first wireless network and the second wireless network.

9. The wireless network of claim 7, the base station controller operable to perform the hard handoff for the mobile station between the transition base transceiver station and the second base transceiver station when the mobile station reaches a border for a hard handoff region, the hard handoff region a portion of the second wireless network.

10. The wireless network of claim 6, the first base transceiver station operable to provide communication for the mobile station in the first wireless network at a first carrier frequency, the transition base transceiver station operable to provide communication for the mobile station in the second wireless network at the first carrier frequency, and the second base transceiver station operable to provide communication for the mobile station in the second wireless network at a second carrier frequency.

11. For use in a border base station in a first wireless network, a method for providing reliable hard handoffs between the first wireless network and a second wireless network, the method comprising:
performing a soft handoff for a mobile station between a first base transceiver station in the first wireless network and a transition base transceiver station in the first wireless network; and
performing a hard handoff for the mobile station between the transition base transceiver station and a second base transceiver station in the second wireless network, the transceiver base transceiver station located in proximity to the second base transceiver station.

12. The method of claim 11, performing the soft handoff for the mobile station comprising performing the soft handoff when the mobile station reaches an overlap region between the first wireless network and the second wireless network.

13. The method of claim 11, performing the hard handoff for the mobile station comprising performing the hard handoff when the mobile station reaches a border for a hard handoff region, the hard handoff region a portion of the second wireless network.

14. The method of claim 11, performing the soft handoff between the first base transceiver station and the transition base transceiver station comprising performing the soft handoff from the first base transceiver station to the transition base transceiver station, and performing the hard handoff between the transition base transceiver station and the second base transceiver station comprising performing the hard handoff from the transition base transceiver station to the second base transceiver station.

15. The method of claim 11, performing the soft handoff between the first base transceiver station and the transition base transceiver station comprising performing the soft handoff from the transition base transceiver station to the first base transceiver station, and performing the hard handoff between the transition base transceiver station and the second base transceiver station comprising performing the hard handoff from the second base transceiver station to the transition base transceiver station.

16. The method of claim 11, further comprising:
providing communication for the mobile station at a first carrier frequency in the first wireless network; and
providing communication for the mobile station at the first carrier frequency and at a second carrier frequency in the second wireless network.

17. The method of claim 16, providing communication for the mobile station at the first carrier frequency in the first wireless network comprising providing communication for the mobile station at the first carrier frequency with the first base transceiver station.

18. The method of claim 16, providing communication for the mobile station at the first carrier frequency in the second wireless network comprising providing communication for the mobile station at the first carrier frequency with the transition base transceiver station.

19. The method of claim 16, providing communication for the mobile station at the second carrier frequency in the second wireless network comprising providing communication for the mobile station at the second carrier frequency with the second base transceiver station.
